(19) United States
(12) Patent Application Publication
(10) Pub. No.: US 2026/0163428 A1
(43) Pub. Date: Jun. 11, 2026

(54) ELECTRIC MOTOR WITH A FLOATING ROTOR

(71) Applicant: iwis mobility systems GmbH & Co. KG, München (DE)

(72) Inventor: Ulrich LINDNER, München (DE)

(21) Appl. No.: 19/409,607

(22) Filed: Dec. 4, 2025

(30) Foreign Application Priority Data
Dec. 11, 2024 (DE) 102024137107.2

(51) Int. Cl. H02K 1/28; H02K 5/24; H02K 7/00; H02K 7/14; H02K 11/21

(52) U.S. Cl. CPC H02K 1/28; H02K 5/24; H02K 7/003; H02K 7/14; H02K 11/21

(57) ABSTRACT

An electric motor with a stator and a rotor includes a coupling side at one axial end for attaching a device to be driven and a sensor side at the other axial end for attaching an encoder device. The rotor is rotatably supported on the coupling side by a spring device and is biased in the direction of the sensor side in such a way that the rotor is rotatably pressed against a fixed stop on the sensor side.

### CROSS-REFERENCE TO RELATED APPLICATION

This application claims priority to foreign German patent application No. DE 102024137107.2, filed on Dec. 11, 2024, the disclosure of which is incorporated by reference in its entirety.

### FIELD OF THE INVENTION

The present invention relates to an electric motor with a stator and a rotor, which comprises a coupling side at one axial end for attaching a device to be driven and a sensor side at the other axial end for attaching an encoder device.

### BACKGROUND

In electrically controlled electric motors, it is important to be able to determine the rotational position of the rotor relative to the stator using a sensor device. The sensor device usually comprises an encoder device attached to the rotor and rotating with it, and a detection device that is attached to the motor and remains stationary relative to the stator. The detection device can be used to detect the relative position of the encoder device, thereby also determining the rotational position of the rotor. In order for the sensor device to function properly, the encoder device and the detection device must be positioned as precisely as possible in relation to each other. At the same time, there is considerable cost pressure and a desire for simple solutions, particularly in the mobility sector.

The invention is therefore based on the task of manufacturing an electric motor of the type mentioned above in a cost-effective manner with high precision.

### SUMMARY OF THE INVENTION

According to the invention, this task is solved by an electric motor according to claim 1. For this purpose, in a generic electric motor, the rotor is rotatably supported on the coupling side by a spring device and preloaded in the direction of the sensor side in such a way that the rotor is rotatably pressed against a fixed stop on the sensor side. In principle, this is only possible if the entire rotor is axially floating and is pressed into position by the spring device. This allows a fixed stop to be used, which can be positioned relatively close to the encoder device. This increases precision. The encoder device can also consist solely of a permanent magnet connected to the rotor.

According to an advantageous embodiment, an axial tolerance chain between an axial contact surface on the rotor for mounting the encoder device and the fixed stop for the rotor can comprise a maximum of two dimensions. As a rule, the axial length of a bearing device is included in this tolerance chain. These are usually precision purchased parts that are manufactured with tight tolerances.

Preferably, the rotor may comprise a rotor shaft, the contact surface for mounting the encoder device may be formed on the rotor shaft, the electric motor may comprise a housing, the fixed stop for the rotor may be formed on the housing, the rotor comprises an axial contact surface of a bearing stage at a distance from the mounting surface, and a bearing device for rotatably arranging the rotor is arranged between the bearing stage and the stop. A rolling bearing, which is available as a high-precision purchased part, is preferably used as the bearing device. The realization of a precise sensor device therefore depends on the distance between the receiving devices and the fixed stop on the housing, the distance between the contact surface and the axial contact surface of the bearing stage, and the length of the bearing device.

Advantageously, the amount of the axial distance between the fixed stop and the contact surface can correspond to a maximum of 0.15 times the height of the encoder device connected to the rotor. Preferably, an attempt is made to bring the fixed stop and the contact surface to approximately the same height (to arrange them in one plane), which also guarantees stable rotation of the encoder device with the aid of the bearing device.

In an advantageous variant, the coupling side of the rotor is supported on a wave spring as a spring device, which in turn is supported on a housing of the electric motor. Wave springs have proven themselves and can exert relatively high spring forces in a very small installation space. In addition, they comprise a high durability. The installation space for the spring device is therefore very small, which has a beneficial effect on the overall size of the electric motor.

It has been found to be advantageous if the coupling side of the rotor is mounted in a bearing arrangement in the housing and the wave spring acts on the fixed part of the bearing arrangement and the rotating part of the bearing arrangement supports the rotor. Rolling bearings, which generally comprise a fixed ball race and a rotating ball race, are particularly suitable for this purpose. Advantageously, the fixed part is the outer ball race and the rotating part is the inner ball race. The rolling elements are arranged between the ball races. Under the usual force conditions, normal ball bearings can be used, provided they can withstand the axial forces occurring here. This further reduces costs.

In the further embodiment, the coupling side of the rotor shaft is assigned to an opening in the housing, and the opening is designed to be open to flow to a pump device that can be attached to the housing and driven by the electric motor, and the opening enables the electric motor and the pump device to be coupled. The electric motor is preferably designed in such a way that the fluid to be pumped by the pump device can enter, which means that a seal in the area of the opening is not necessary. If the fluid to be pumped is, for example, hydraulic oil, the bearing device is also permanently lubricated at the same time.

Preferably, the housing can form a connecting collar for connection to the pump device, at least one pump opening for introducing or discharging a hydraulic fluid into or out of the housing of the electric motor can be provided in addition to the opening, and both the opening and the at least one pump opening can be surrounded by the connecting collar. Both the opening and the at least one pump opening are therefore located in the area surrounded by the connecting collar, so that the connecting collar can also be the sealing point between the motor housing and the pump device. The at least one pump opening ensures that the pump device also fills the motor housing with the hydraulic fluid. The hydraulic fluid can therefore also be used to dissipate heat from the motor housing.

Advantageously, the coupling side of the rotor shaft may comprise an end-face bore with coupling teeth for connection to a pump wheel of the pump device, wherein axial length compensation is possible by means of the coupling teeth. However, the reverse embodiment is also possible.

According to one variant, the connecting collar is mounted eccentrically to the rotor axis, wherein the at least one pump opening is arcuate around the rotor axis in the half of the area bounded by the connecting collar, which comprises the greatest distance between the connecting collar and the rotor axis at its center. The area enclosed by the connecting collar is generally circular. If this is divided into two semicircles, the greatest distance between the rotor axis and the connecting collar should also be located in the center of one of the semicircles. The at least one pump opening is then also arranged in this semicircle. This allows the at least one pump opening to also be designed to be flow-optimized, for example, by increasing or decreasing its cross-section depending on the inflow or outflow.

A design in which a hydraulically acting damping device connected essentially in parallel to the spring device is provided is particularly advantageous. Depending on the installation position, this can dampen the axial vibrations of the rotor. This makes the motor more durable and less sensitive to vibration loads, for example, vibrations during driving.

Preferably, the housing of the electric motor can be filled with a hydraulic fluid during operation to form the damping device, wherein the axial vibrations of the rotor are damped by means of this hydraulic fluid filling. Filling the housing with a hydraulic fluid can therefore serve not only to dissipate heat, but also to provide damping.

Furthermore, the invention relates to an electric motor according to one of claims 1 to 12 with a housing and a pump device to be driven, wherein the housing of the electric motor and the pump device are connected in a flow-connected manner in order to keep the housing of the electric motor filled with a hydraulic fluid by means of the pump device. The pump device generally fulfills another main task, for example, it serves as steering assistance in a vehicle. In addition, at least part of the hydraulic fluid flow can also be directed through the motor housing in such a way that, on the one hand, heat is dissipated and, on the other hand, a damping function is provided.

### BRIEF DESCRIPTION OF THE DRAWINGS

An embodiment of the present invention is explained in more detail below with reference to the drawings.

FIG. 1 a perspective top view of an electric motor according to the invention,

FIG. 2 a perspective bottom view of the electric motor from FIG. 1,

FIG. 3 the electric motor from FIG. 1 in full section,

FIG. 4 a perspective top view of the rotor laminated core with inserted magnets,

FIG. 5 a front view of the rotor,

FIG. 6 a partially sectioned front view of an alternative rotor, and

FIG. 7 a perspective enlarged top view of the wave spring from FIG. 3.

### DETAILED DESCRIPTION

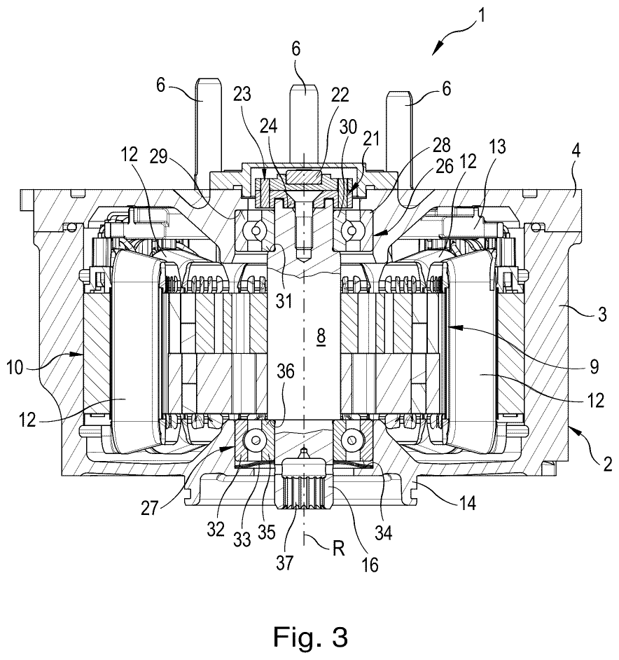

The electric motor 1 has a housing 2 comprising a housing body 3 and a bearing shield 4. The housing body 3 is essentially pot-shaped and open at the top. The bearing shield 4 is attached to this open side of the housing body 3. The bearing shield 4 is preferably screwed to the housing body 3. Six connection feed-throughs 5 are formed in the bearing shield 4. Six electrical connections of the electric motor 1, designed as connection tabs 6, exit the electric motor 1 at the connection feed-throughs 5. The connection feed-throughs 5 seal the interior of the housing 2 against fluids from the outside. The connection tabs 6 are connected to electronics located outside the housing 2 and are used to supply power and control the coils 12 of the electric motor 1 (see also FIG. 3).

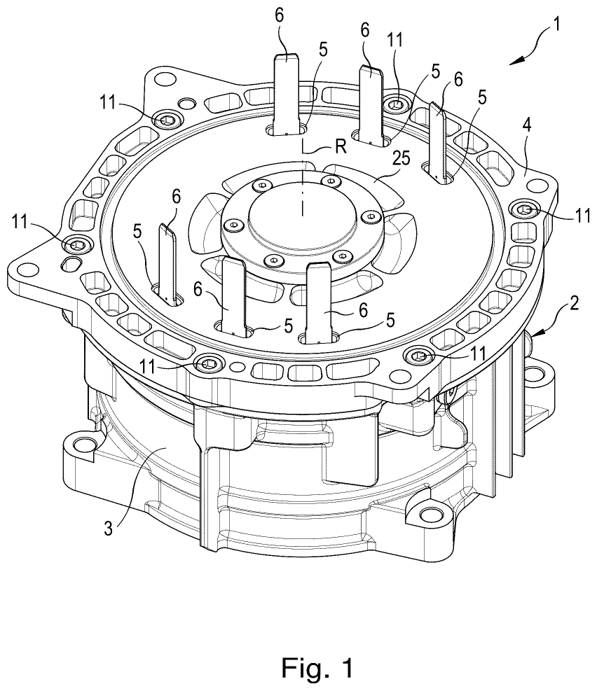

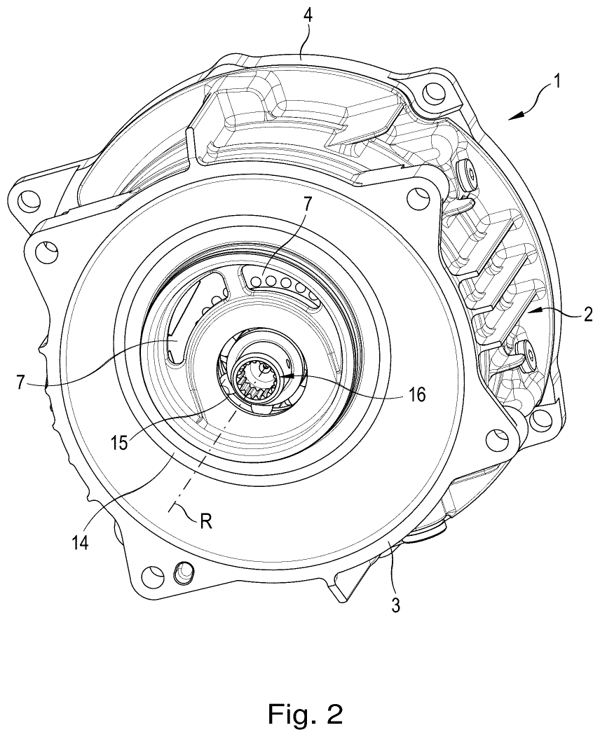

FIG. 2 shows a perspective view of the electric motor 1 from FIG. 1 from below. The electric motor 1 drives a hydraulic unit as part of a steering system for trucks. On the underside, the housing 2 or housing body 3 comprises pump openings 7 so that hydraulic oil can enter and exit the electric motor 1. The electric motor 1 therefore runs in oil.

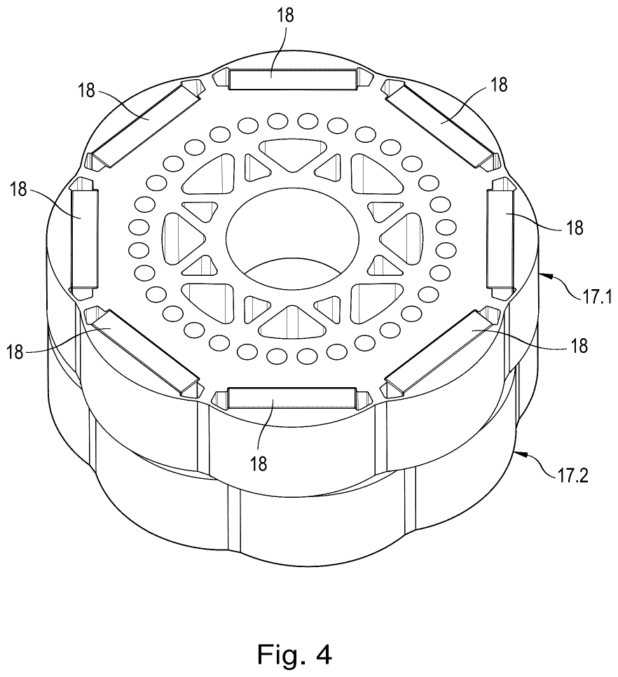

FIG. 3 shows a full section through the electric motor 1 from FIG. 1. As already described, the electric motor 1 comprises a housing 2 with a housing body 3 and a bearing shield 4. The bearing shield 4 is screwed to the housing body 3 by means of screws 11. A rotatably mounted rotor 9 with motor shaft 8 and a stator 10 are arranged in the housing 2. The stator 10 comprises a plurality of coils 12, and the rotor 9 is equipped with two lamination stacks 17.1 and 17.2 twisted relative to each other and with permanent magnets 18 (see also FIG. 4). A switching ring 13 is attached to the stator 10, which serves to contact the coils 12. The switching ring 13 comprises a redundant design, which is why the six connection tabs 6 are provided. Two connection tabs 6 are assigned to each phase of the three-phase motor. This makes it possible to control only half of the coils 12 of the stator 10 for emergency operation.

For connection to a pump device (not shown), the underside of the housing body 3 is provided with an annular connecting collar 14, which can engage sealingly in a corresponding opening in the pump device. The connecting collar 14 is arranged eccentrically to a rotor axis R. Within the area bounded by the connecting collar 14, a circular opening 15 is therefore provided in addition to the two pump openings 7 for the lead-through of the lower coupling end 16 of the motor shaft 8. The two pump openings 7 are each curved and taper towards one end. Furthermore, the two pump openings 7 are arranged in the half of the area enclosed by the connecting collar 14 which comprises the greatest distance between the rotor axis R and the connecting collar 14. If the area bounded by the connecting collar 14 is divided into two equal halves and the intersection line of the two halves runs perpendicular to the greatest distance between the rotor axis R and the connecting collar 14, then both pump openings 7 are located in the half of the area in which the greatest distance between the rotor axis R and the connecting collar 14 is also located in the center.

Both the opening 15 and the pump openings 7 are designed to be open to the flow so that hydraulic oil can enter and exit the housing 2 from the pump device.

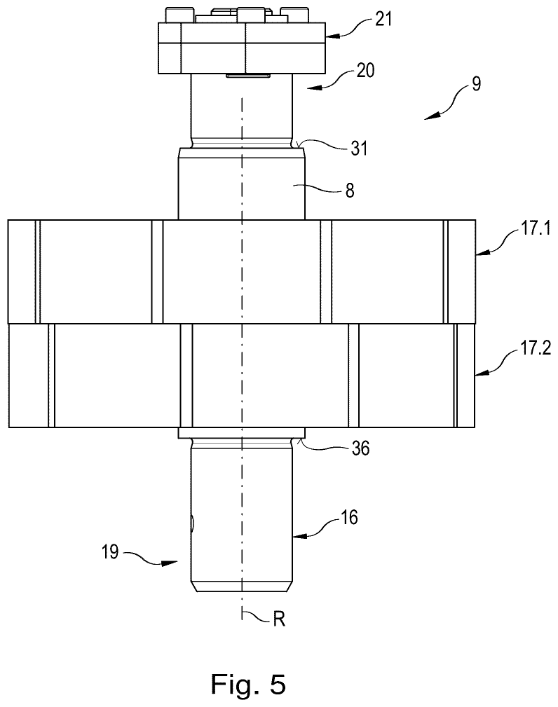

The rotor 9 has a coupling side at the lower axial end 19, which comprises the coupling end 16 of the motor shaft 8, and a sensor side at the upper axial end 20, to which an encoder device 21 is attached (see also FIG. 5). The encoder device 21 is part of a sensor device, which is not shown in detail, whose receiver device, which is also not shown, is located outside the housing 2, centered on the bearing shield 4. Usually, a control unit is plugged onto the connection tabs 6, which comprises the receiver device located above the encoder device 21. The receiver device detects the position of the encoder device 21 for controlling the electric motor 1. In the present case, the encoder device 21 comprises a permanent magnet 22 polarized in a predetermined direction, which is attached to the sensor side of the rotor 9 by means of a holding arrangement 23. For this purpose, the encoder device 21 sits on a front mounting surface 24 on the rotor 9. The bearing shield 4 comprises a sealed and removable cover 25 in the center, which allows access to the encoder device 21. The cover 25 separates the encoder device 21 from the receiver device, which is not shown. The receiver device is capable of determining the rotational position of the encoder device 21, i.e., the permanent magnet 22, and thus also the rotational position of the rotor 9 relative to the stator 8.

The rotor 9 is mounted in the housing 2 so that it can rotate on both its sensor side and its coupling side by means of a rolling bearing 26 and 27, respectively. The outer ball race 28 of the rolling bearing 26 on the sensor side rests against a fixed stop 29 of the housing 2, i.e., the bearing shield 4. The inner ball race 30 of the rolling bearing 26 rests against an axial contact surface 31 of a bearing step on the motor shaft 8. The fit between the bearing shield 4 and the rolling bearing 26 is a clearance fit, meaning that it is a floating bearing. The outer ball race 32 of the rolling bearing 27 on the coupling side rests against a wave spring 33 (see also FIG. 7), which in turn is supported by a shoulder 34 of the housing 2, i.e. the housing body 3. The shoulder 34 extends annularly around the opening 15. The inner ball race 35 of the rolling bearing 27 rests against an axial contact surface 36 of a bearing step on the motor shaft 8. The fit between the housing body 3 and the rolling bearing 27 is a clearance fit, meaning that it is a floating bearing. This arrangement means that the entire rotor 9 is mounted in a floating manner in the housing 2 and is preloaded in the direction of the sensor side by means of the wave spring 33. The fixed stop 29 serves as the upper stop, against which the upper rolling bearing 26 is pressed due to the spring force of the wave spring 33.

This design results in a relatively short tolerance chain between the contact surface 24 for the encoder device 21 and the fixed stop 29. The distance between the contact surface 24 and the axial contact surface 31 and the width of the rolling bearing 26 are decisive for accuracy. Accordingly, only two dimensions are involved in this short tolerance chain. This arrangement also makes it possible to position the contact surface 24 and the fixed stop approximately in the same plane, with the distance thus being a maximum of 0.15 times the height of the encoder device 21. This positions the encoder device 21 relatively close to the rolling bearing 26 and guides it stably in its rotational movement.

In order for the electric motor 1 to be connected to the pump device (not shown) by means of the connecting collar 14, a front bore 37 with coupling teeth for connection to a pump wheel of the pump device is additionally provided in the coupling end 16 of the motor shaft 8. The coupling teeth allow axial length compensation to take place.

During operation, the electric motor 1 drives the pump device. The pumped hydraulic oil is also pumped into and out of the housing 2 of the electric motor 1 via the pump openings 7, so that it is constantly filled with hydraulic oil. Due to the rotation of the rotor 8, the hydraulic oil is also moved within the housing 2. The oil flowing in and out can, on the one hand, remove heat from the electric motor 1. In addition, the rolling bearings 26 and 27 run continuously in oil and are well lubricated. However, the hydraulic fluid filling the housing 2 also provides axial damping for the rotor 9, so that any axial vibrations that occur are buffered accordingly. The vibration damping thus takes place parallel to the spring effect of the wave spring 33 by means of a constant contact with the fixed stop 29.

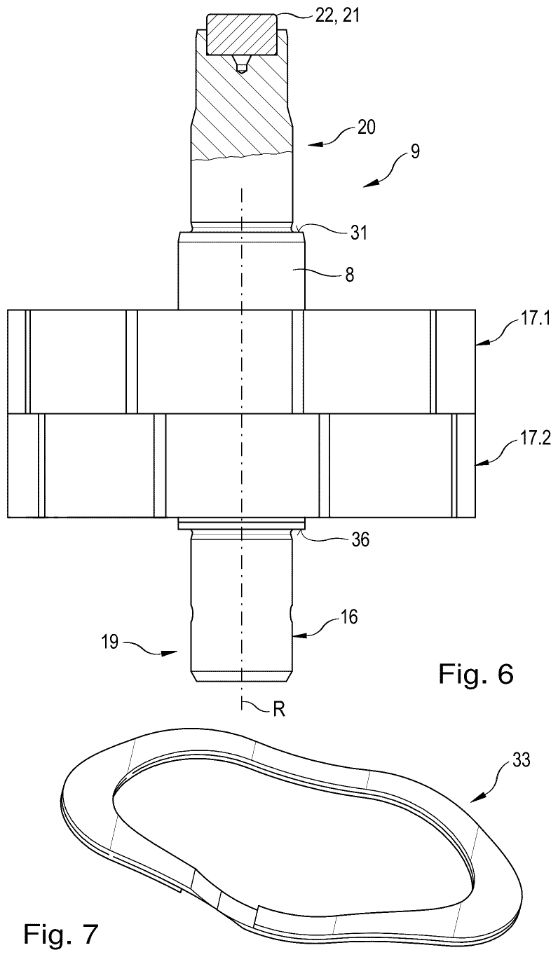

FIG. 6 shows an alternative design of a rotor 9. Here, the encoder device 21 comprises only the permanent magnet 22, which is inserted into a basic bore at the end of the motor shaft 8. It is primarily attached by means of an adhesive process.

### LIST OF REFERENCE SIGNS

1 electric motor
2 housing
3 housing body
4 bearing shield
5 connection feed-through
6 connection tab
7 pump opening
8 motor shaft
9 rotor
10 stator
11 screw
12 coil
13 switching ring
14 connecting collar
15 opening
16 coupling end
17.1 first lamination stack
17.2 second lamination stack
18 permanent magnet
19 lower axial end
20 upper axial end
21 encoder device
22 permanent magnet
23 holding arrangement
24 support surface
25 cover
26 upper rolling bearing
27 lower rolling bearing
28 outer ball race
29 fixed stop
30 inner ball race
31 axial contact surface
32 outer ball race
33 wave spring
34 shoulder
35 inner ball race
36 axial contact surface
37 end-face bore
r rotor axis

1. An electric motor with a stator and a rotor, which has a coupling side at one axial end for attaching a device to be driven and a sensor side at the other axial end for attaching an encoder device, wherein the rotor is rotatably supported on the coupling side by a spring device and is biased in the direction of the sensor side in such a way that the rotor is rotatably pressed against a fixed stop on the sensor side.

2. The electric motor according to claim 1, wherein an axial tolerance chain between an axial mounting surface on the rotor for mounting the encoder device and the fixed stop for the rotor comprises a maximum of two dimensions.

3. The electric motor according to claim 1, wherein the rotor comprises a motor shaft, the seating surface for seating the encoder device is formed on the motor shaft, the electric motor comprises a housing, the fixed stop for the rotor is formed on the housing, the rotor comprises an axial contact surface of a bearing step at a distance from the mounting surface, and a bearing device for rotatably arranging the rotor is arranged between the bearing step and the fixed stop.

4. The electric motor according to claim 3, wherein the amount of the axial distance between the fixed stop and the contact surface corresponds to a maximum of 0.15 times the height of the encoder device connected to the rotor.

5. The electric motor according to claim 1, wherein the coupling side of the rotor is supported on a wave spring as a spring device, which in turn is supported on a housing of the electric motor.

6. The electric motor according to claim 5, wherein the coupling side of the rotor is mounted in the housing in a bearing device and the wave spring acts on the fixed part of the bearing device and the rotating part of the bearing device supports the rotor.

7. The electric motor according to claim 1, wherein the coupling side of the motor shaft is associated with an opening in the housing and the opening is designed to be open to flow to a pump device that can be attached to the housing and driven by the electric motor, and the opening enables the electric motor and the pump device to be coupled.

8. The electric motor according to claim 7, wherein the housing forms a connecting collar for connection to the pump device, at least one pump opening for or out of the housing of the electric motor, and both the opening and the at least one pump opening are surrounded by the connecting collar.

9. The electric motor according to claim 1, wherein the coupling side of the motor shaft comprises an end-face bore with coupling teeth for connecting to a pump wheel of the pump device, wherein axial length compensation is possible by means of the coupling teeth.

10. The electric motor according to claim 8, wherein the connecting collar is mounted eccentrically to the rotor axis (R) and the at least one pump opening is located in an arc around the rotor axis (R) in the half of the area bounded by the connecting collar which comprises the greatest distance between the connecting collar and the rotor axis (R) at its center.

11. The electric motor according to claim 1, wherein a hydraulically acting damping device connected substantially in parallel to the spring device is provided to damp the axial vibrations of the rotor.

12. The electric motor according to claim 11, wherein, in order to form the damping device, the housing of the electric motor is filled with a hydraulic fluid during operation and the axial vibrations of the rotor are damped by means of this hydraulic fluid filling.

13. The electric motor according to claim 1, with a housing and a pump device to be driven, wherein the housing of the electric motor and the pump device are connected in a flow-connected manner in order to keep the housing of the electric motor filled with a hydraulic fluid by means of the pump device.
